(19) United States
(12) Patent Application Publication
(10) Pub. No.: US 2013/0268100 A1
(43) Pub. Date: Oct. 10, 2013

(54) MANIPULATION CONTROL APPARATUS, MANIPULATION CONTROL PROGRAM, AND MANIPULATION CONTROL METHOD

(71) Applicants: Satoru Miyata, Sagamihara-shi (JP); Tsuyoshi Yamaguchi, Kawasaki-shi (JP); Seiji Agata, Sagamihara-shi (JP); Takeharu Uchida, Tokyo (JP); Yasushi Sugaya, Tokyo (JP)

(72) Inventors: Satoru Miyata, Sagamihara-shi (JP); Tsuyoshi Yamaguchi, Kawasaki-shi (JP); Seiji Agata, Sagamihara-shi (JP); Takeharu Uchida, Tokyo (JP); Yasushi Sugaya, Tokyo (JP)

(73) Assignee: JVC KENWOOD CORPORATION, Yokohama-shi (JP)

(21) Appl. No.: 13/701,070

(22) PCT Filed: Dec. 27, 2011
(86) PCT No.: PCT/JP2011/080351

§ 371 Date: Nov. 30, 2012

(30) Foreign Application Priority Data
Dec. 27, 2010 (JP) 2010-290727

(51) Int. Cl. G05B 19/042

(52) U.S. Cl. CPC G05B 19/0426
USPC 700/88

(57) ABSTRACT

A manipulation control apparatus includes a first obtaining unit which obtains manipulation information for indicating user manipulation, and a first control unit which performs control according to the manipulation indicated by the obtained manipulation information. Also, the manipulation control apparatus additionally includes a storage unit which stores condition information for indicating a condition that is valid when a user manipulation is highly likely to be performed again. In addition, the manipulation control apparatus includes a preserve unit which preserves the manipulation information in the storage unit when the manipulation indicated by the obtained manipulation information satisfies a condition indicated by stored condition information.

### TECHNICAL FIELD

The present invention relates to a manipulation control apparatus, a manipulation control program, and a manipulation control method, which perform control according to a manipulation.

### BACKGROUND ART

Electronic devices having a function of recording a manipulation history are widely known. For example, Patent Reference 1 discloses a vehicle-mounted information terminal that starts storing a manipulation history when a manipulation storage start switch is pressed down, and finishes storing the manipulation history when a manipulation storage finish switch is pressed down. When any one of stored manipulations is selected, the vehicle-mounted information terminal performs an operation according to the selected manipulations.

### PRIOR ART REFERENCE

### Patent Reference

(Patent Reference 1) Japanese Laid-Open Patent Publication No. 2008-45968

### DISCLOSURE OF THE INVENTION

### Technical Problem

In the technology disclosed in Patent Reference 1, a user has to press down the manipulation storage start switch and the manipulation storage finish switch in order to start and finish registration of the manipulation history, respectively, and thus manipulation is complicated.

Also, the vehicle-mounted information terminal records all manipulations so performed from the time when the manipulation storage start switch is pressed down to the time when the manipulation storage finish switch is pressed down. Thus, the number of recorded manipulations is increased high.

Here, due to the high number of recorded manipulations, it is difficult to select and designate a manipulation according to a desired operation from among the numerous recorded manipulations. As such, a conventional apparatus that has a manipulation recording function has a low user convenience (manipulability).

Considering such problems, the present invention provides a manipulation control apparatus, a manipulation control program, and a manipulation control method, which have high convenience or manipulability.

### Technical Solution

According to an aspect of the present invention, there is provided a manipulation control apparatus including: a first obtaining unit which obtains manipulation information for indicating combined manipulations that are combinations of user manipulations; a first control unit which performs control according to the combined manipulations indicated by the manipulation information obtained by the first obtaining unit; a storage unit which stores condition information for indicating a condition that is valid when the combined manipulations indicated by the manipulation information obtained by the first obtaining unit are highly likely to be performed again by the user; a preserve unit which preserves the manipulation information in the storage unit when the combined manipulations indicated by the manipulation information obtained by the first obtaining unit satisfy the condition indicated by the condition information stored in the storage unit; a second obtaining unit which obtains reattempt designation information designating a combined manipulation corresponding to control of performing again by the user from among the combined manipulations indicated by the manipulation information preserved by the preserve unit; and a second control unit which performs the control according to the combined manipulation designated using the reattempt designation information obtained by the second obtaining unit.

The storage unit may match and store information for indicating types of the combined manipulations with a plurality of pieces of condition information respectively indicating a plurality of conditions that are valid when the types of combined manipulations are highly likely to be performed by the user again, the second obtaining unit may additionally obtain designation condition information for indicating the condition so information designated by the user from among the plurality of pieces of condition information stored in the storage unit, and the preserve unit may preserve the manipulation information in the storage unit when a condition indicated by the designation condition information obtained by the second obtaining unit is valid from among the plurality of pieces of condition information matching the information for indicating the types of combined manipulations indicated by the manipulation information obtained by the first obtaining unit.

The manipulation control apparatus may further include a delete unit which deletes at least one piece of the plurality of manipulation information from the storage unit when the number of pieces of manipulation information stored in the storage unit reaches a predetermined number, wherein the preserve unit may preserve the manipulation information obtained by the first obtaining unit in the storage unit storing the number of pieces of manipulation information that is less than the predetermined number; the second obtaining unit may additionally obtain deletion-restricted designation information for designating manipulation information of which deletion is restricted from among the plurality of pieces of manipulation information preserved in the storage unit, and the delete unit may delete at least one piece of the plurality of manipulation information, which is different from the manipulation information designated as the deletion-restricted designation information obtained by the second obtaining unit.

The combined manipulation highly likely to be performed again may include a tuning manipulation of changing a frequency set in a tuner used to receive a radio broadcast or television broadcast, and the condition indicated by the condition information may include a condition that a following tuning manipulation is not performed over a first period of time or above after the tuning operation has been performed.

The combined manipulation highly likely to be performed again may include a combined manipulation of reproducing audio or an image, and the condition indicated by the condition information may include a condition that the combined manipulation reproducing the audio or image is a combination of a manipulation of searching audio or an image and a manipulation of reproducing found audio or image.

The combined manipulation highly likely to be performed again may include a manipulation of setting an audio output apparatus for outputting audio, or a manipulation of setting a display apparatus for displaying an image, and the condition indicated by the condition information may include a condition that the manipulation of setting the audio output apparatus is a manipulation of setting quality of the audio output by the audio output apparatus, or a condition that the manipulation of setting the display apparatus is a manipulation of setting brightness of the image displayed by the display apparatus.

According to another aspect of the present invention, there is provided a manipulation control program, which operates a computer as: a first obtaining unit which obtains manipulation information for indicating combined manipulations that are combinations of user manipulations; a first control unit which performs control according to the combined manipulations indicated by the manipulation information obtained by the first obtaining unit; a preserve unit which preserves the manipulation information in the storage unit when the combined manipulations indicated by the manipulation information obtained by the first obtaining unit satisfy a condition that is valid when the combined manipulations are highly likely to be performed again by the user; a second obtaining unit which obtains reattempt designation information designating a combined manipulation corresponding to control of performing again by the user from among the combined manipulations indicated by the manipulation information preserved by the preserve unit; and a second control unit which performs the control according to the combined manipulation designated using the reattempt designation information obtained by the second obtaining unit.

According to another aspect of the present invention, there is provided a manipulation control method including: a first obtaining operation for obtaining manipulation information for indicating combined manipulations that are combinations of user manipulations; a first control operation for performing control according to the combined manipulations indicated by the manipulation information obtained by the first obtaining operation; a preserve operation for preserving the manipulation information in the storage unit when the combined manipulations indicated by the manipulation information obtained by the first obtaining operation satisfy a condition that is valid when the combined manipulations are highly likely to be performed again by the user; a second obtaining operation for obtaining reattempt designation information designating a combined manipulation corresponding to control of performing again by the user from among the combined manipulations indicated by the manipulation information preserved by the preserve operation; and a second control operation for performing the control according to the combined manipulation designated using the reattempt designation information obtained by the second obtaining operation.

### Advantageous Effects

According to the present invention, a manipulation control apparatus, a manipulation control program, and a manipulation control method, which have high convenience or manipulability, are provided,

### BRIEF DESCRIPTION OF THE DRAWINGS

FIG. 1 is a perspective view showing an example of a vehicle-mounted apparatus including a manipulation control apparatus, according to an embodiment of the present invention;

FIG. 2 is a hardware configuration diagram showing a configuration example of the vehicle-mounted apparatus;

FIG. 3 is a flowchart showing an example of a preservation condition setting process performed by the manipulation control apparatus, according to an embodiment of the present invention;

FIG. 4 is a functional block diagram showing an example of functions of the manipulation control apparatus;

FIGS. 5A and 5B are a diagram showing an example of a preservation condition table;

FIG. 6A is a diagram showing an example of a manipulation category select screen;

FIG. 6B is a diagram showing an example of a preservation condition select screen;

FIG. 7 is a diagram showing an example of a manipulation history table;

FIG. 8 is a flowchart showing an example of a history preserving process performed by the manipulation control apparatus;

FIGS. 9A and 9B are a flowchart showing an example of a history displaying process performed by the manipulation control apparatus;

FIG. 10A is a diagram showing a display example of a manipulation history;

FIG. 10B is a diagram showing a display example of displaying that manipulation information is locked;

FIG. 10C is a diagram showing a display example of a manipulation history when manipulation information is not locked; and

FIG. 10D is a diagram showing a display example of a manipulation history when manipulation information is locked.

### BEST MODE FOR CARRYING OUT THE INVENTION

Hereinafter, a manipulation control apparatus 110 according to an embodiment of the present invention, and a vehicle-mounted apparatus 100 controlled by the manipulation control apparatus 110 are described with reference to accompanying drawings.

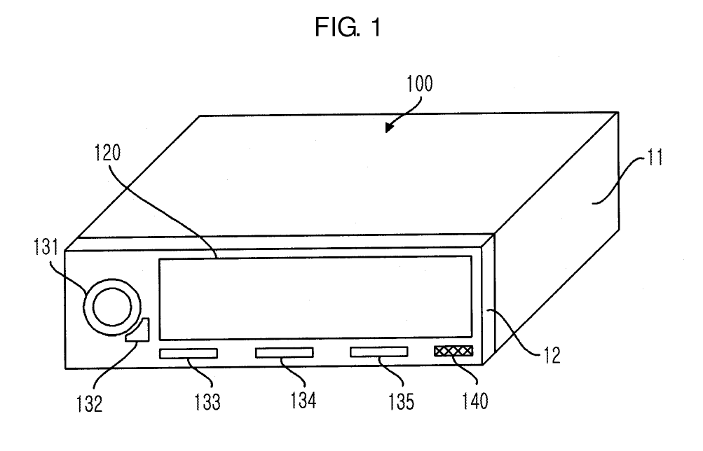

The vehicle-mounted apparatus 100, including the manipulation control apparatus 110 according to an embodiment of the present invention, includes a case 11 having a box shape, and a manipulation panel 12 disposed on a front surface of the case 11, as shown in FIG. 1.

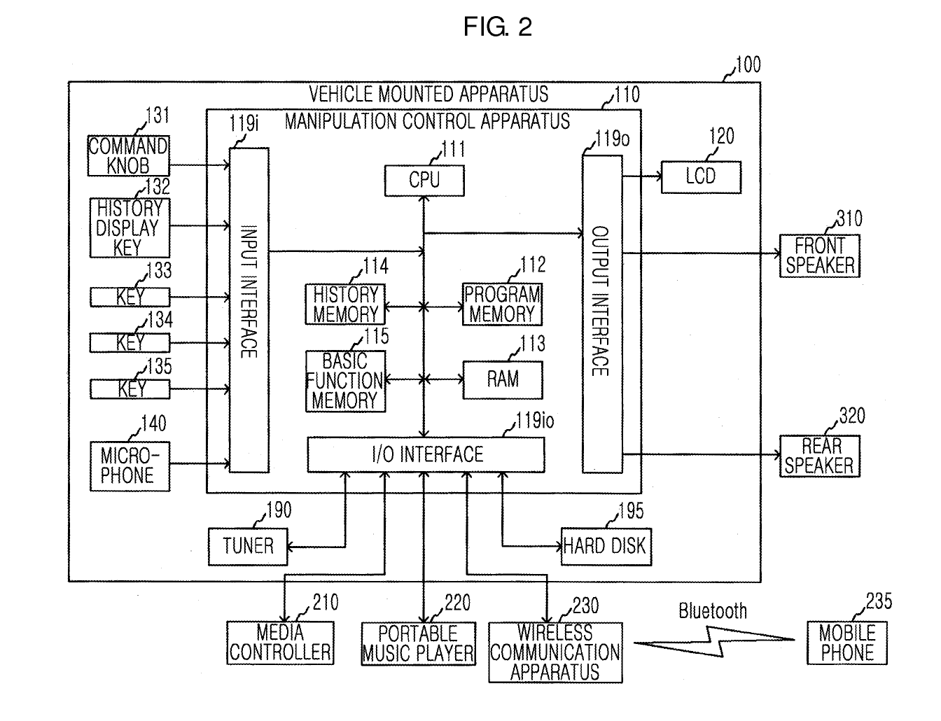

As shown in FIG. 2, the manipulation control apparatus 110, a liquid crystal display (LCD) 120, a command knob 131, a history display key 132, various keys 133 through 135, a microphone 140, a tuner 190. and a hard disk apparatus 195 are accommodated in the case 11.

The LCD 120 is controlled by the manipulation control apparatus 110, and displays various images. The LCD 120 is provided in the manipulation panel 12 such that a user can see a display screen of the LCD 120 from the outside of the vehicle-mounted apparatus 100 through an opening of the manipulation panel 12.

The command knob 131, the history display key 132, and the keys 133 through 135 supply a signal according to user manipulation to the manipulation control apparatus 110. In detail, the command knob 131 has a rod shape and one end of the command knob 131 protrudes from an opening of the manipulation panel 12. The end of the command knob 131 protruding from the manipulation panel 12 is pressed down in a longitudinal direction and is rotated around a central axis by the user. The history display key 132 and the keys 133 through 135 protrude from the opening of the manipulation panel 12 and are pressed down by the user.

The microphone 140 converts audio around the vehicle-mounted apparatus 100 into an analog audio signal, converts the analog audio signal into a digital audio signal by using an analog-to-digital (A/D) converter, and supplies the digital audio signal to the manipulation control apparatus 110.

The tuner 190 receives electric waves at a frequency set by the manipulation control apparatus 110, demodulates an audio signal, and supplies the demodulated audio signal to the manipulation control apparatus 110. The manipulation control apparatus 110 outputs the audio signal demodulated by the tuner 190 to a front speaker 310 and a rear speaker 320. A received frequency and a modulating method of the tuner 190 are arbitrary, and for example, either of electric waves used for a radio broadcast and electric waves used for a television broadcast may be used.

The hard disk apparatus 195 stores a plurality of pieces of arbitrary data, for example, content information for indicating audio, such as an MP3 file and a WAV file, and content information for indicating an image, such as a Moving Picture Experts Group (MPEG) file and an audio video interleave (AVI) file. The manipulation control apparatus 110 reads content information stored in the hard disk apparatus 195, generates an audio signal based on the read content information, and outputs the generated audio signal to the front and rear speakers 310 and 320. Also, the manipulation control apparatus 110 generates an image signal indicating an image to be displayed based on the read content information and outputs the image signal to the LCD 120.

The manipulation control apparatus 110 includes a central processing unit (CPU) 111, a program memory 112, a random access memory (RAM) 113, a history memory 114, a basic function memory 115, an input interface 119i, an output interface 119o, an input and output interface 119io, and a bus connecting them with each other.

The CPU 111 executes a program preserved in the program memory 112 to control the vehicle-mounted apparatus 100 in general.

The program memory 112 stores a program executed by the CPU 111, for example, an operating system (OS) or application program.

The RAM 113 functions as a work area of the CPU 111 and stores a program to be executed or various types of data.

The history memory 114 and the basic function memory 115 include a nonvolatile memory capable of overwriting, such as a flash memory or a complementary metal oxide semiconductor (CMOS) memory backed up by a battery or the like. The history memory 114 stores history information for indicating a history of user manipulations. The basic function memory 115 stores various pieces of data used to execute programs for realizing basic functions of the vehicle-mounted apparatus 100 from the factory shipment.

The input interface 119i supplies signals supplied from the command knob 131, the history display key 132, the keys 133 through 135, and the microphone 140 to the CPU 111. The output interface 1190 outputs a signal output from the CPU 111 to the LCD 120 and the front and rear speakers 310 and 320 connected to the vehicle-mounted apparatus 100. The input and output interface 119io relays signals transmitted and received among the tuner 190 and hard disk apparatus 195 included in the vehicle-mounted apparatus 100; a media controller 210, a portable music player 220, and a wireless communication apparatus 230 which are connected to the vehicle-mounted apparatus 100; and the CPU 111.

The media controller 210, for example, reads data, such as content information, from a recording medium, such as a flash memory like an SD card, a compact disc (CD), a digital versatile disc (DVD), or a Blu-ray disc (registered trademark), and supplies the data to the CPU 111 via the input and output interface 119io. The media controller 210 also receives data output from the CPU 111 via the input and output interface 119io and records the data on the recording medium.

An iPod (registered trademark), for example, is used as the portable music player 220. The portable music player 220 stores a plurality of pieces of content information including musical piece data and description information about a musical piece, such as an artists name or a music title. The portable music player 220 searches for desired content information from among the plurality of pieces of content information according to control of the manipulation control apparatus 110. For example, the portable music player 220 searches for musical piece data of a musical piece played by an artist who has the name that includes a keyword output from the manipulation control apparatus 110, on the basis of description information. Also, the portable music player 220 reproduces the found musical piece data, and outputs an audio signal of the reproduced musical piece to the manipulation control apparatus 110. The manipulation control apparatus 110 outputs the input audio signal to the front and rear speakers 310 and 320 via the output interface 119o.

The wireless communication apparatus 230 wirelessly connects a portable terminal 235 of the user, according to Bluetooth standards (registered trademark) or the like. The portable terminal 235 is, for example, a mobile phone, a smart phone, or a PDA. The manipulation control apparatus 110 outputs a signal for indicating a phone number and a command signal for calling the phone number to the wireless communication apparatus 230, in accordance with user manipulation. The wireless communication apparatus 230 wirelessly transmits the command signal output from the manipulation control apparatus 110 to the portable terminal 235. The portable terminal 235 calls the phone number indicated by the received signal, in response to the command signal.

While the user is making a call over the portable terminal 235, the manipulation control apparatus 110 supplies the audio signal output from the microphone 140 to the wireless communication apparatus 230. The wireless communication apparatus 230 transmits the audio signal supplied from the manipulation control apparatus 110 to the portable terminal 235. The portable terminal 235 wirelessly transmits the received audio signal to a base station. Also, upon receiving a wireless signal including an audio signal from the base station, the portable terminal 235 demodulates the audio signal and transmits the demodulated audio signal to the wireless communication apparatus 230. The wireless communication apparatus 230 supplies the received audio signal to the manipulation control apparatus 110. The manipulation control apparatus 110 outputs the supplied audio signal to the front and rear speakers 310 and 320.

Then, when the user performs a manipulation of ending the call, the manipulation control apparatus 110 outputs a command signal for transmitting a hang-up signal (i.e., a command to end the call) to the wireless communication apparatus 230, in response to the manipulation. The wireless communication apparatus 230 transmits the command signal from the manipulation control apparatus 110 to the portable terminal 235. Upon receiving the command signal, the portable terminal 235 transmits the hang-up signal to the base station according to the received command signal.

Also, when there is an incoming call (i.e., when a call signal is received from the base station), the portable terminal 235 transmits information about the incoming call to the manipulation control apparatus 110 via the wireless communication apparatus 230. The manipulation control apparatus 110 outputs a command signal for reception (i.e., a command to transmit a response signal) to the wireless communication apparatus 230, in response to user manipulation allowing reception. The wireless communication apparatus 230 transmits the command signal to the portable terminal 235. The portable terminal 235 transmits a response signal to the base station in response to the received command signal.

The vehicle-mounted apparatus 100 performs an operation according to a manipulation or a combination of manipulations performed by the user on the command knob 131, the history display key 132, and the various keys 133 through 135. For an example, when the user manipulates (rotates) the command knob 131, the so vehicle-mounted apparatus 100 selects an option displayed on the LCD 120. Alternatively, when the user manipulates (presses down) the command knob 131, the vehicle-mounted apparatus 100 performs an operation of displaying a selected option.

In order to perform such operations, the manipulation control apparatus 110 performs a control process according to a combination of manipulations (hereinafter, referred to as a combined manipulation) indicated by signals output from the command knob 131, the history display key 132, and the various keys 133 through 135.

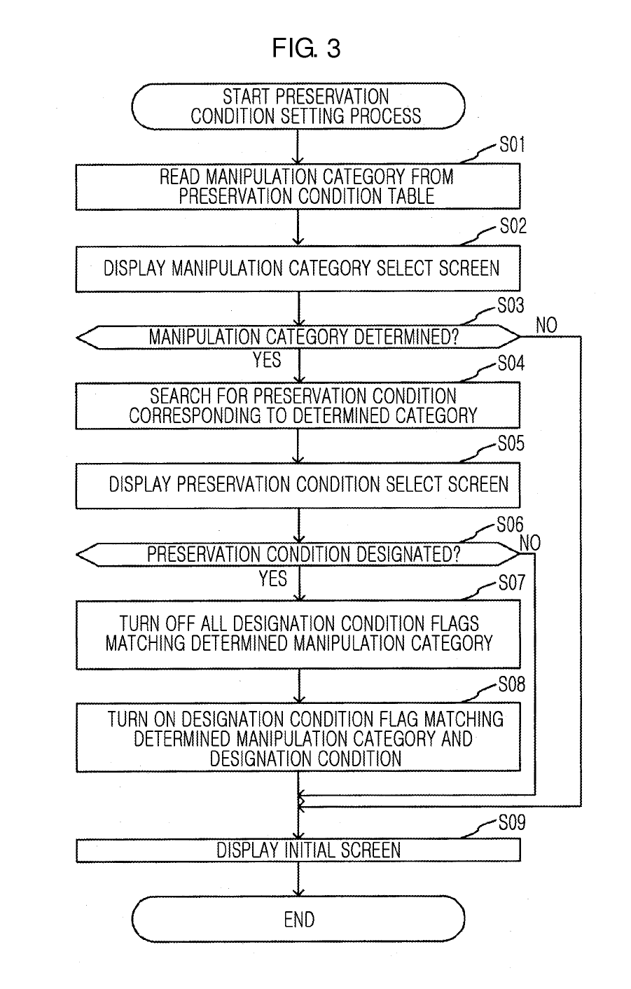

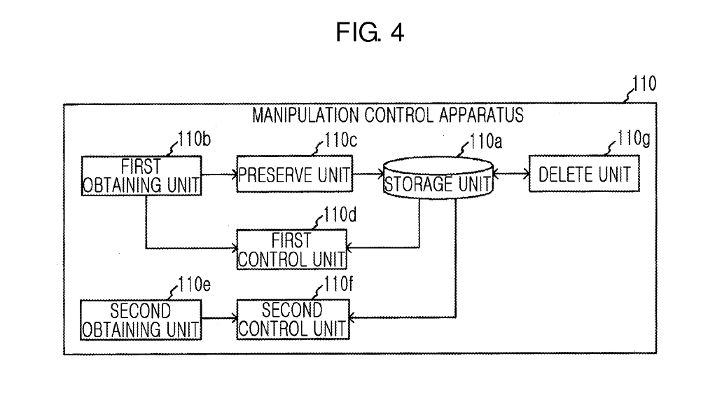

The CPU 111 of the manipulation control apparatus 110 performs a preservation condition setting process shown in FIG. 3 so as to set conditions of preserving manipulation information for indicating a combined manipulation in the history memory 114. By performing the preservation condition setting process, the CPU 111 operates as a first obtaining unit 110b, a second obtaining unit 110e, a preserve unit 110c, a first control unit 110d, a second control unit 110f, and a delete unit 110g, as shown in FIG. 4. Specifically, the CPU 111 operates as a storage unit 110a by cooperating with the history memory 114 and the basic function memory 115.

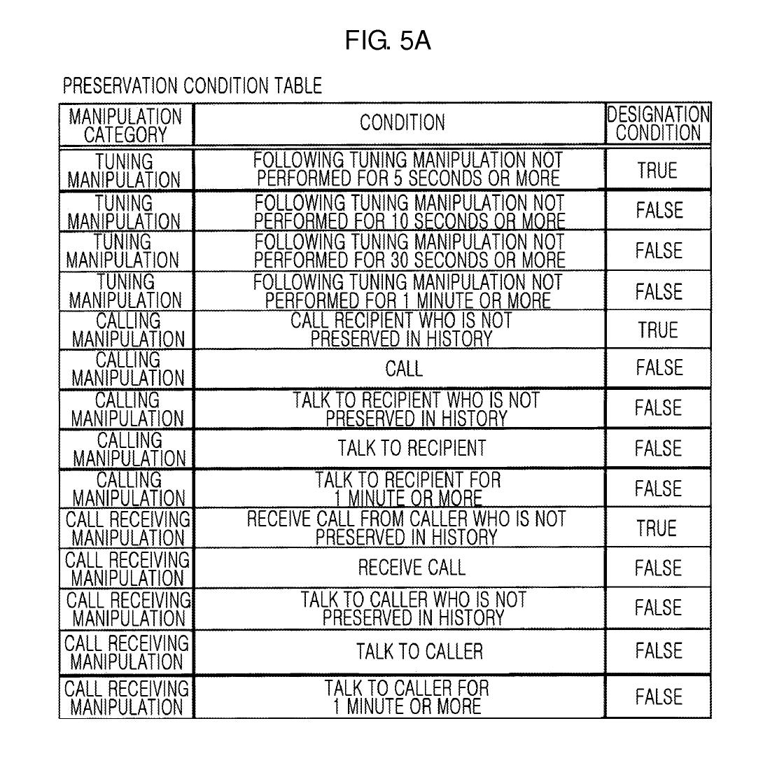

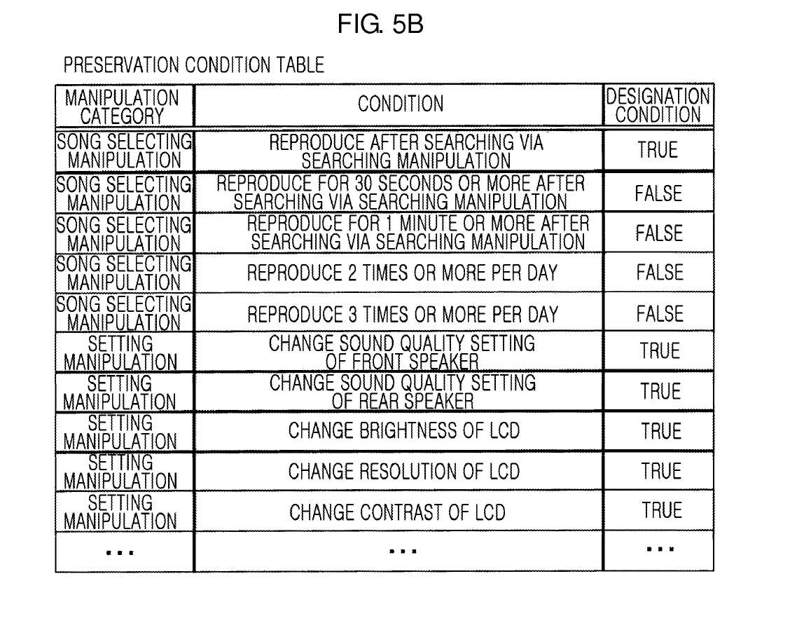

The storage unit 110a stores a preservation condition table shown in FIGS. 5A and 5B. The preservation condition table matches and stores i) type information for indicating types (classification) of combined manipulations (hereinafter, also referred to as a manipulation category), ii) condition information for indicating conditions for preserving the manipulation information for indicating the combined manipulations in the storage unit 110a (hereinafter, referred to as a preservation condition), and a designation condition flag indicating whether a corresponding preservation condition is designated (selected employed) by the user (hereinafter, referred to as a designation condition). Here, the preservation condition indicated by the condition information is a condition that is valid when the combined manipulation indicated by the type information matching the condition information is highly likely to be performed again by the user.

The manipulation categories are classified according to apparatuses controlled according to the combined manipulations. In detail, the types of the combined manipulations include: i) a manipulation of changing a frequency set by the tuner 190 (hereinafter, referred to as a tuning manipulation), ii) a manipulation of making a call over the portable terminal 235 (hereinafter, referred to as a calling manipulation), iii) a manipulation of receiving an incoming call on the portable terminal 235 when there is an incoming call (hereinafter, referred to as a call receiving manipulation), iv) a manipulation of selecting a musical piece to be reproduced from among a plurality of musical pieces indicated by a plurality of pieces of content information stored in the hard disk apparatus 195, the media controller 210, or the portable music player 220, respectively (hereinafter, referred to as a song selecting manipulation), and v) a manipulation of changing settings of the front or rear speaker 310 or 320 and a manipulation of changing settings of the LCD 120 (hereinafter, referred to as a setting manipulation).

Entries in the first through fourth lines of the preservation condition table of FIG. 5A preserve information indicating that the manipulation information for indicating a tuning manipulation is preserved in the storage unit 110a when a condition that a following tuning manipulation is not performed over a first period of time after the tuning manipulation is performed is valid. In other words, the information indicating that the manipulation information for indicating the tuning manipulation is preserved is preserved since it is highly likely that the tuning manipulation is to be performed again by the user if the condition that the following tuning manipulation is not performed over the first w period of time after the tuning manipulation is performed is valid.

If the user wants to listen to a certain broadcast, the user adjusts a received frequency of a tuner via a tuning manipulation so as to listen to audio output from the front speaker 310 or the like. If the user determines that the broadcasted contents are not what the user wants to listen, the user changes a frequency set in the tuner 190 via a tuning manipulation. Here, if the user determines that the broadcasted contents are not what the user wants to listen, a time from the tuning manipulation to the following tuning manipulation is generally shorter than the first period of time. Also, a broadcast program is generally broadcasted according to a predetermined period, for example, every week or at a certain time of a certain day of the week. Accordingly, if the user likes the broadcast program, it is highly likely that the user manipulates the vehicle-mounted apparatus 100 according to the predetermined period so as to receive the broadcast program. Thus, in the present embodiment, the user may arbitrarily designate a first period of time from among 5 seconds, 10 seconds, 30 seconds, and 1 minute.

A suitable value for the first period of time may be, for example, determined by one of ordinary skill in the art via experiments.

Entries in the fifth through ninth lines of the preservation condition table of FIG. 5A preserve information indicating that manipulation information for indicating a calling manipulation is preserved in the storage unit 110a when a condition that the calling manipulation is a manipulation of making a call over the portable terminal 235 with a phone number different from those stored in the storage unit 110a is valid. The manipulation history is stored when the receiving phone number is different from the stored phone numbers because it is sufficient that one piece of manipulation information for indicating the combined manipulation of making a call over the portable terminal 235 with the same phone number is stored in the storage unit 110a only once.

Similarly, the tenth through fourteenth lines of the preservation condition table of FIG. 5A preserve information indicating that manipulation information for indicating a call receiving manipulation that is performed is preserved in the storage unit 110a when a condition that the call receiving manipulation is a manipulation of receiving an incoming call on the portable terminal 235 with a phone number different from those stored in the storage unit 110a is valid.

Also, the preservation condition table of FIG. 53 preserves information indicating that manipulation information for indicating a song selecting manipulation that is performed is preserved in the storage unit 110a when a condition that the song selecting manipulation is a combination of a manipulation of searching for a predetermined piece of content information from among the plurality of pieces of content information stored in the hard disk apparatus 195, the media controller 210, or the portable music player 220, a manipulation of selecting one or more musical pieces indicated by the found content information, and a manipulation of reproducing the selected one or more musical pieces is valid. Since a musical piece selected and reproduced by the user in musical pieces searched from among a plurality of musical pieces is likely to be a musical piece that the user actively wants to listen or a musical piece that the user likes, it is highly likely that the song selecting manipulation of selecting the musical piece is repeatedly performed. Accordingly, manipulation information for indicating the song selecting manipulation is preserved in the storage unit 110a as history information.

Also, the preservation condition table of FIG. 5B preserves information indicating that manipulation information for indicating a setting manipulation is preserved in the storage unit 110a as history information when a condition that the setting manipulation is a manipulation of changing sound quality of the front or rear speaker 310 or 320 is valid. Since a lot of users repeatedly listen to a wanted musical piece at a desired sound quality, it is highly likely for the manipulation of changing sound quality to be repeatedly performed. Thus, the manipulation information for indicating the performed setting manipulation is preserved in the storage unit 110a as history information. Similarly, the preservation condition table of FIG. 5B preserves information indicating that the performed manipulation is preserved in the storage unit 110a as manipulation history information when a condition that the performed manipulation is a manipulation of setting brightness of the LCD 120 is valid. Since a lot of users repeatedly view a wanted image at a desired brightness, the information for indicating the manipulation of changing the brightness of the LCD 120 is preserved as the manipulation history information.

Next, the preservation condition setting process shown in FIG. 3 is described in detail.

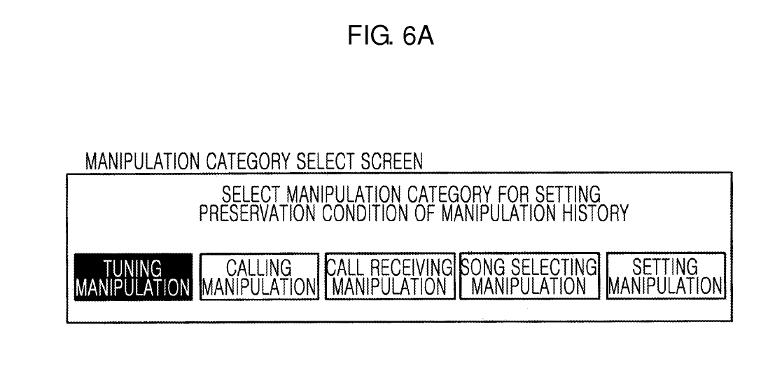

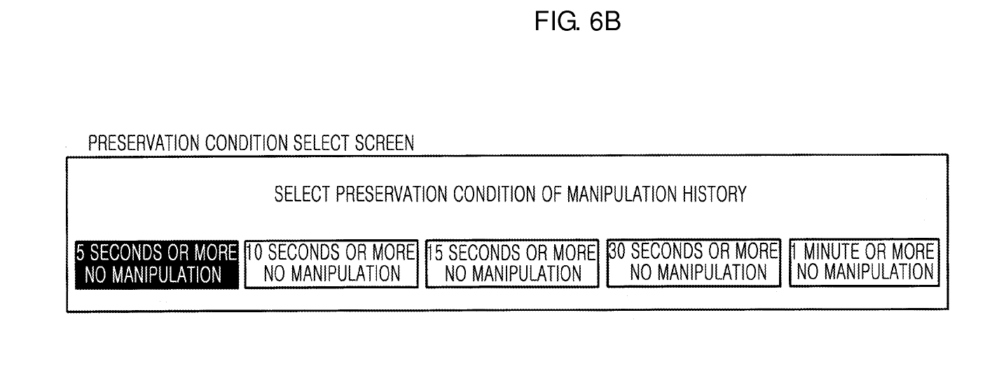

When the key 133 of FIG. 1 is pressed down, the CPU 111 starts the preservation condition setting process of FIG. 3. First, the first control unit 110d (CPU 111) reads one or more pieces of type information for indicating the manipulation category from the preservation condition table of FIGS. 5A and 5B (operation S01). Next, the first control unit 110d obtains information for indicating a manipulation category select screen shown in FIG. 6A from the storage unit 110a, and displays a screen indicated by the obtained information on the LCD 120 (operation S02). Then, the first control unit 110d displays the manipulation category displayed by the one or more pieces of type information on the manipulation category select screen.

Next, the first control unit 110d determines whether a category for designating a preservation condition is determined based on manipulation information (i.e., a combination of signals indicating manipulations) indicating a combined manipulation obtained by the first obtaining unit 110b from the command knob 131 of FIG. 1 (operation S03). In detail, the user rotates the command knob 131 of FIG. 1 so as to select one manipulation category from a plurality of manipulation categories shown in FIG. 6A, and presses down the command knob 131 so as to determine the selected manipulation category as the category for designating a preservation condition. The first obtaining unit 110b sequentially obtains manipulation information for indicating manipulations performed by the user on the command knob 131. The first control unit 110d determines whether the category for designating a preservation condition is determined based on the manipulation information.

If the category is determined (designated) in operation S03 (operation S03; Yes), the first control unit 110d searches for condition information matching the type information for indicating the determined category in the preservation condition table of FIGS. 5A and 5B (operation S04). Next, the first control unit 110d obtains information for indicating a preservation condition select screen shown in FIG. 6B from the storage unit 110a, and displays a screen indicated by the obtained information on the LCD 120 (operation S05). Then, the first control unit 110d displays a preservation condition indicated by one or more pieces of condition information on the preservation condition select screen.

Next, the first control unit 110d determines whether a preservation condition is designated, based on whether the first obtaining unit 110b obtained designation condition information for indicating a designation condition designated by the user from among condition information for indicating preservation condition displayed on the preservation condition select screen (operation S06). Also, like operation S03, the user designates a designation condition.

If it is determined that the preservation condition is designated in operation S06 (operation S06: Yes), the first control unit 110d sets all designation condition flags to be OFF, wherein all designation condition flags are designation condition flags which are preserved in the preservation condition table of FIGS. 5A and 5B and matches the manipulation category determined in operation S03 (hereinafter, referred to as a determined manipulation category) (operation S07). Next, the first control unit 110d turns designation condition flags to be ON, wherein the designation condition flags matches type information for indicating the determined manipulation category and condition information for indicating the designation condition (operation S08).

Otherwise, if the category is not determined in operation S03 (operation S03; No), if it is determined that the preservation condition is not designated in operation 506 (operation S06; No), or after operation S08, the first control unit 110d obtains information for indicating an initial screen from the storage unit 110a, controls the LCD 120 to display a screen indicated by the obtained information (operation S09), and then ends the preservation condition setting process.

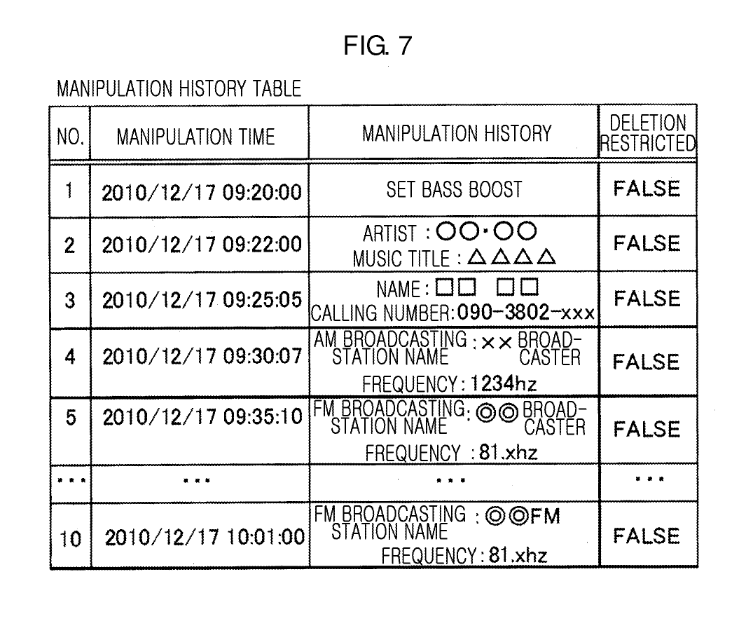

Here, the storage unit 110a stores a manipulation history table shown in FIG. 7. The manipulation history table of FIG. 7 has a plurality of records which preserves a plurality of pieces of information (hereinafter, referred to as history information) where manipulation time information for indicating a time when a combined manipulation is performed, manipulation information for indicating the combined manipulation, and deletion-restricted information for indicating whether the manipulation information is designated by the user as information of which deletion is restricted are matched.

In detail, history information stored in the manipulation history table of FIG. 7 shows that a “manipulation of setting a bass boost” (i.e., setting a lower band of output audio to be stronger than previous time) was performed on the front and rear speakers 310 and 320 at “9:20 am on 17 Dec. 2010”. Similarly, history information of the manipulation history table shows that a “manipulation of reproducing music titled └└└└ played by an artist named o o·oo” was performed at “9:22 am on 17 Dec. 2010”. Also, history information of the manipulation history table shows that a “manipulation of calling a number 090-3802-xxxx (i.e., calling manipulation)” was performed at “9:25 am on 17 Dec. 2010”.

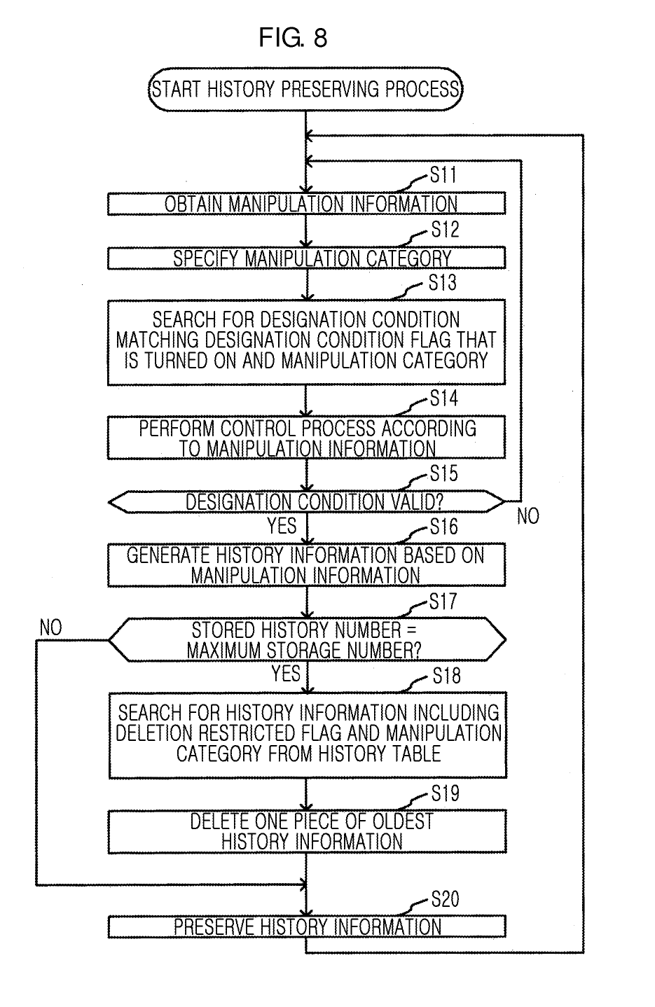

Here, when the manipulation control apparatus 110 controlling the vehicle-mounted apparatus 100 is activated, a history preserving process shown in FIG. 8 is performed. When the history preserving process is started, the first obtaining unit 110b of FIG. 4 obtains a combination of signals indicating manipulation information from the command knob 131, the history display key 132, the keys 133 through 135, or the portable music player 220 (operation S11). Next, the preserve unit 110c specifies a type of combined manipulation (i.e., a manipulation category), based on an apparatus to be manipulated with the combined manipulation indicated by manipulation information (operation S12), Next, the preserve unit 110c searches for condition information for indicating a preservation condition (i.e., designation condition) which matches a is designation condition flag that is turned to be ON and type intonation for indicating the manipulation category specified in operation S12, in the preservation condition table of FIGS. 5A and 5B (operation S13).

Then, the first control unit 110d performs a control process according to the combined manipulation indicated by the manipulation information obtained in operation S11 (operation S14). In detail, when the combined manipulation indicated by the manipulation information obtained in operation S11 is a tuning manipulation, the first control unit 110d performs a control process of setting a frequency of the tuner 190 of FIG. 2 according to the tuning manipulation. Alternatively, when the combined manipulation indicated by the manipulation information is a calling or call receiving manipulation, the first control unit 110d performs a control process of outputting a command for instructing the wireless communication apparatus 230 of FIG. 2 to make a call and information for indicating a phone number of a recipient, or a control process of outputting a command of receiving a call. Alternatively, when the combined manipulation indicated by the manipulation information is a song selecting manipulation, the first control unit 110d performs a control process of outputting information designating selected audio or image and a command of reproducing the designated audio or image to the portable music player 220. Alternatively, the first control unit 110d may perform a process of reproducing audio or an image selected by the user from among audio or images stored in the hard disk apparatus 195 or a recording medium controlled by the media controller 210. Alternatively, furthermore, when the combined manipulation indicated by the manipulation information is a setting manipulation, the first control unit 110d may perform a control process of outputting a command of changing a setting according to the setting manipulation, and information for indicating the setting details to the front or rear speaker 310 or 320 or the LCD 120 of FIG. 2.

After operation S14 of FIG. 8, the preserve unit 110c determines whether the designation condition indicated by the condition information searched in operation S13 is valid (operation S15). Here, if it is determined that the designation condition is not valid (operation S15; No), the preserve unit 110c repeats the process from operation S11.

Otherwise, if it is determined that the designation condition is valid in operation S15 (operation S15; Yes), the preserve unit 110c generates history information based on the manipulation information obtained in operation S11, for example, a system time managed by an operating system (OS) (operation S16). Then, the delete unit 110g of FIG. 4 determines whether the number of pieces of history information stored in the manipulation history table of FIG. 7 (hereinafter. referred to as stored history number) is equal to a predetermined maximum storage number (operation S17). Here, information about the maximum storage number is stored in the storage unit 110a in advance.

Here, if it is determined that the stored history number and the maximum storage number are equal (operation S17; Yes), the delete unit 110g searches for a plurality of pieces of history information including a deletion-restricted flag that is turned to be OFF and the type information for indicating the manipulation category specified in operation S12, in the manipulation history table of FIG. 7 (operation S18). Next, the delete unit 110g deletes one piece of history information including information for indicating the oldest manipulation time from among the one or more pieces of found history information (operation S19). Alternatively, the delete unit 110g may delete a plurality of pieces of history information in an order from the oldest manipulation time indicated by the information included in the history information.

Otherwise, if it is determined that the stored history number is not equal to the maximum storage number in operation S17 (operation S17; No), or after operation S19, the preserve unit 110c preserves the history information generated in operation S16 in the manipulation history table of FIG. 7 (operation S20). Then, processes from operation S11 are repeated.

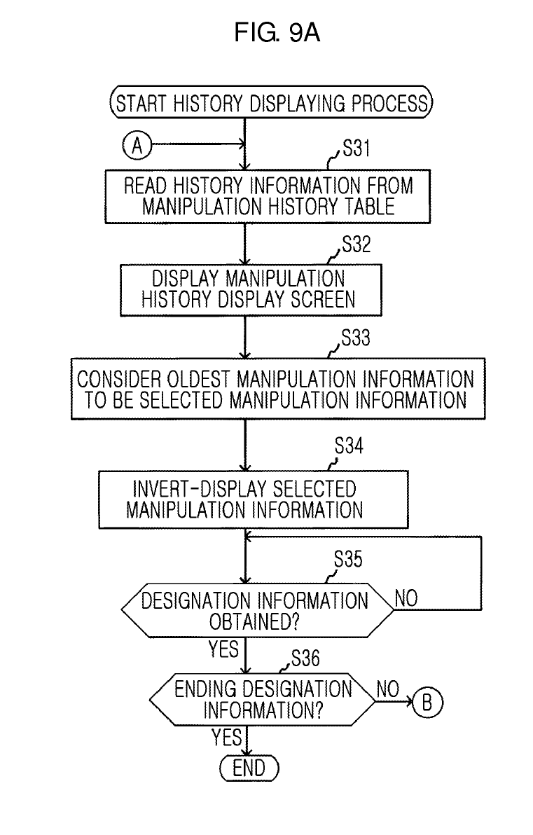

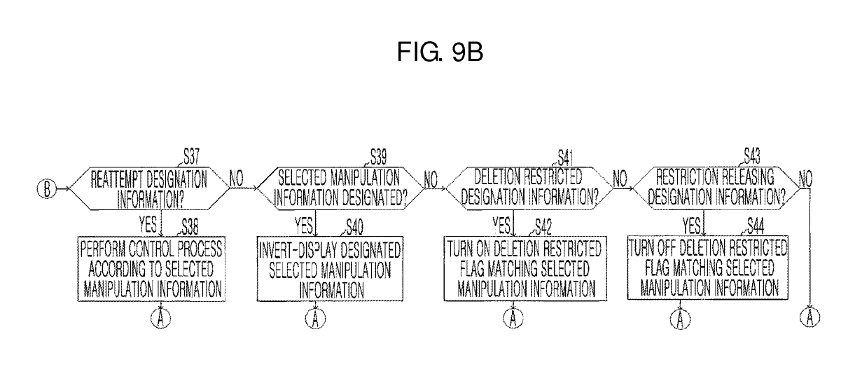

Here, when the history display key 132 of FIG. 1 is pressed down, a history displaying process shown in FIGS. 9A and 9B is performed. When the history displaying process is started, the first control unit 110d reads a plurality of pieces of history information from the manipulation history table of FIG. 7 (operation S31). Then, the first control unit 110d obtains information for indicating a manipulation history display screen from the storage unit 110a, and displays the manipulation history display screen indicated by the obtained information on the LCD 120 of FIG. 2 (operation S32).

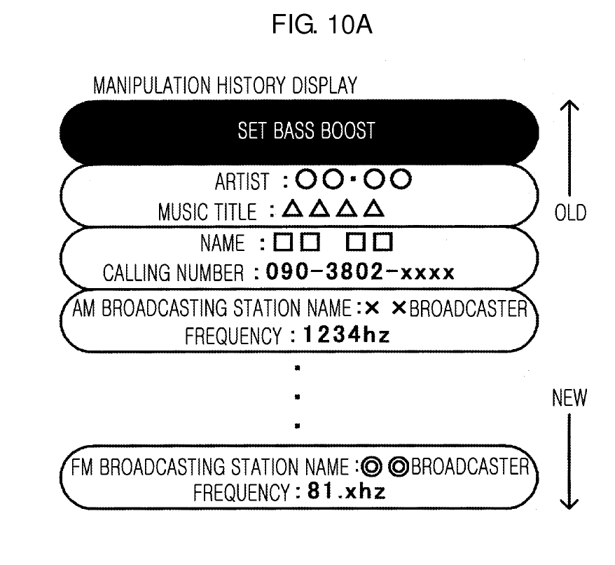

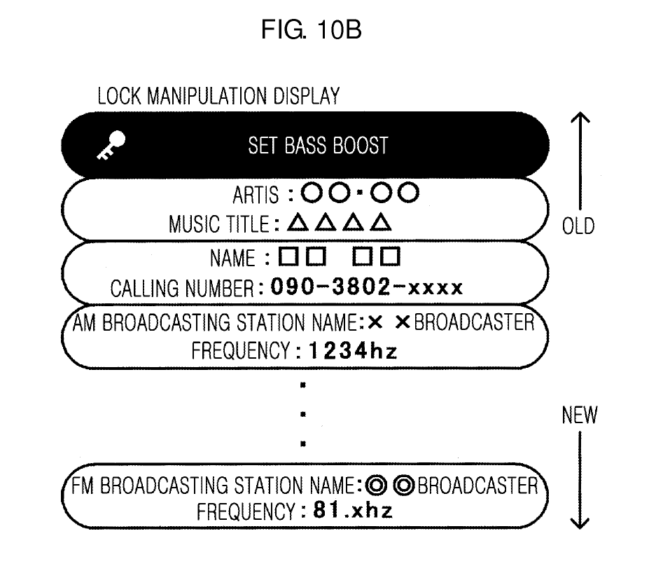

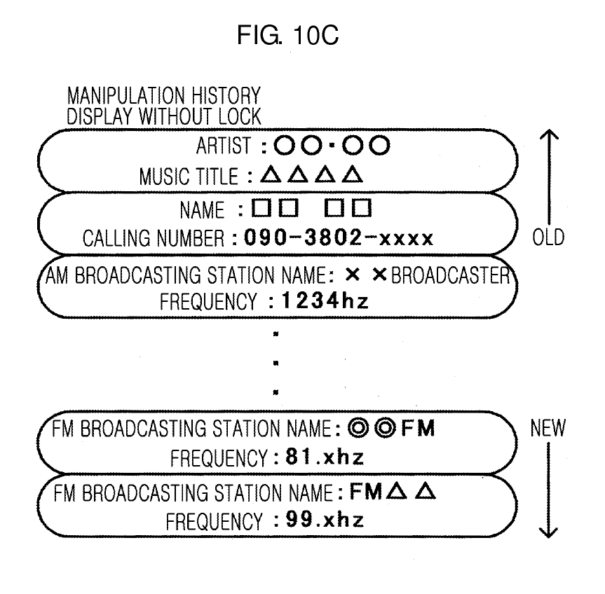

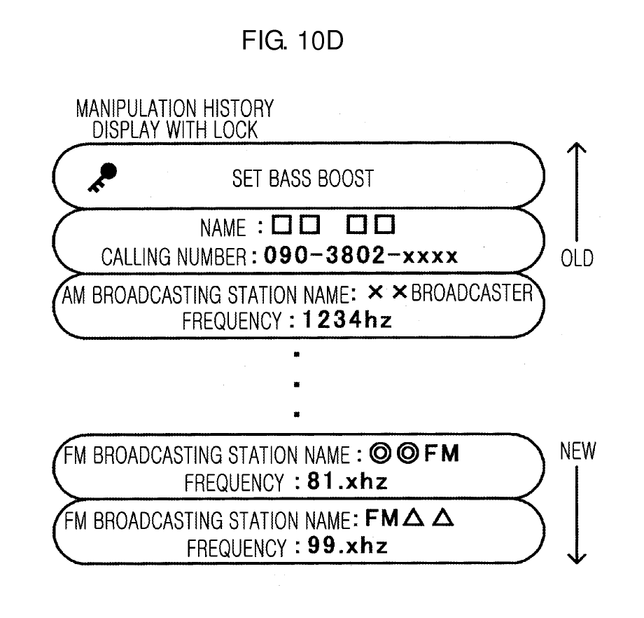

Next, the first control unit 110d displays manipulation information included in the plurality of pieces of history information read in operation S31 on the manipulation history display screen, as shown in FIG. 10A. Also, hereinafter, it is assumed that manipulation information of matching the oldest manipulation time information is manipulation information selected by the user (hereinafter, referred to as selected manipulation information) (operation S33). Then, the first control unit 110d performs inverted display of the selected manipulation information (operation S34).

Then, the second control unit 110f determines whether the second obtaining unit 110e obtained a signal indicating designation information for designating a process performed by the second control unit 110f, from the command knob 131, the history display key 132, and the various keys 133 through 135 of FIG. 1 (operation S35). Here, if it is determined that the second obtaining unit 110e did not obtain the designation information (operation S35; No), the second control unit 110f repeats operation S35 after standing by for a predetermined period of time. On the other hand, if it is determined that the second obtaining unit 110e obtained the designation information (operation S35; Yes), the second control unit 110f determines whether the obtained designation information is ending designation information for ending the process performed by the second control unit 110f (ending the history displaying process) (operation S36). Here, if it is determined that the obtained designation information is the ending designation information (operation S36; Yes), the second control unit 110f ends the history displaying process.

In this regard, it is determined whether the designation information obtained by the second obtaining unit 110e is reattempt designation information where the manipulation indicated by the selected manipulation information that inverted display is performed like FIG. 10A is designated as a manipulation corresponding to a control process that is performed again in the vehicle-mounted apparatus 100 by the user (operation S37). In detail, the user inputs the reattempt designation information to the command knob 131 of FIG. 1 by pressing down the command knob 131.

If it is determined that the obtained designation information is the reattempt designation information in operation S37 (operation S37; Yes), the second control unit 110f performs a control process according to a manipulation indicated by the selected manipulation information (operation S38). Then, the processes from operation 531 are repeated.

Otherwise, if it is determined that the obtained designation information is not the reattempt designation information in operation S37 (operation S37; No), the second control unit 110f determines whether the obtained designation information designates the selected manipulation information (operation S39). In detail, the user rotates the command knob 131 of FIG. 1 to the right so as to input designation information that designates manipulation information displayed on a portion lower than the selected manipulation information that inverted display is performed before a manipulation as the selected manipulation information, to the command knob 131.

If it is determined that the obtained designation information is information designating the selected manipulation information in operation S39 (operation S39; Yes), the second control unit 110f ends inverted display of the selected manipulation information, and then sets the manipulation information designated as the designation information to new selected manipulation information, and then performs inverted display of the new selected manipulation information (operation S40). Then, the processes from operation S31 are repeated.

Otherwise, if it is determined that the obtained designation information is not the designation information for designating the selected manipulation information in operation S39 (operation S39; No), the second control unit 110f determines whether the obtained designation information is designation information for designating manipulation information of which deletion is restricted (hereinafter, referred to as deletion-restricted designation information) (operation S41).

If it is determined that the obtained designation information is the so deletion-restricted designation information in operation S41 (operation S41; Yes), the second control unit 110f turns a deletion-restricted flag to be ON. wherein the deletion-restricted flag is preserved in the manipulation history table of FIG. 7 and matches the selected manipulation information (operation S42). Also, the second control unit 110f links an image indicating a deletion restriction, such as an image showing a key of FIG. 10B, to the selected manipulation information, and displays the image on the LCD 120 of FIG. 1. Then, the processes from operation S31 are repeated.

Otherwise, if it is determined that the obtained designation information is not the deletion-restricted designation information in operation S41 (operation S41; No), the second control unit 110f determines whether the obtained designation information is designation information for designating the manipulation information that releases deletion restriction (hereinafter, referred to as restriction releasing designation information (operation S43).

If it is determined that the obtained designation information is not the restriction releasing designation information in operation S43 (operation S43; No), the processes from operation S31 are repeated. On the other hand, if it is determined that the obtained designation information is the restriction releasing designation information (operation S43; Yes), the second control unit 110f turns a deletion-restricted flag to be OFF, wherein the deletion-restricted flag is preserved in the manipulation history table of FIG. 7 and matches the selected manipulation information (operation S44). Also, the second control unit 110f ends the displaying of the image indicating that the deletion restriction is applied. Then, the processes from operation S31 are repeated.

When the maximum storage number of pieces of history information as shown in FIG. 10A is preserved in the manipulation history table of FIG. 7 and manipulation information included in any history information is not locked (i.e., is not restricted from being deleted), the oldest manipulation information “Set Bass Boost” is deleted as shown in FIG. 10C, and new manipulation information is preserved. On the other hand, when the maximum storage number of pieces of history information identical to the history information shown in FIG. 10A is preserved in the manipulation history table of FIG. 7, and the manipulation information “Set Bass Boost” included in the oldest history information is locked as shown in FIG. 10B, before new manipulation information is preserved, the second oldest manipulation information “Artist: oo·oo Music Title: └└└└” is deleted as shown in FIG. 10D, and then the new manipulation information is preserved. Accordingly, the locked manipulation information “Set Bass Boost” is not deleted and remains in the manipulation history table of FIG. 7.

According to such a structure, manipulation information for indicating a combined manipulation performed by a user is preserved in the storage unit 110a if a condition that is valid when the combined manipulation is highly likely to be performed again by the user is satisfied. Consequently, user convenience is improved since the user does not have to perform a manipulation different from the combined manipulation, for example, pressing a special switch, so as to preserve the manipulation information. Also, since the manipulation information is preserved when the condition is satisfied, the number of pieces of manipulation information preserved in the storage unit 110a is difficult to be increased. Accordingly, user convenience is improved since the user can easily and quickly designate a manipulation (i.e., shorten a time required to perform a manipulation) desired from the combined manipulation indicated by the preserved manipulation information. Specifically, not only a driver at the wheel and a passenger in a passenger seat assisting the driver can be freed from the inconvenience of registering manipulation information by combining manipulations performed on the vehicle-mounted apparatus 100 or the inconvenience of repeatedly performing a combination of complex operations, but also the driver can drive safely.

Also, according to such structures, the manipulation information for indicating the combined manipulation is preserved when the condition designated by the user is valid according to types of combined manipulations. Accordingly, not only the number of pieces of manipulation information preserved in the storage unit 110a is difficult to be increased, but also a manipulation desired from the combined manipulation indicated by the preserved manipulation information can be easily designated, and thus, user convenience is further improved with respect to the vehicle-mounted apparatus 100, for example, when the user is at the wheel.

Also, according to such structures, when the number of pieces of stored manipulation information reaches a predetermined number, at least one piece of manipulation information different from manipulation information designated by the user as manipulation information of which deletion is restricted is deleted, and thus, not only do the number of pieces of manipulation information preserved in the storage unit 110a not exceed the predetermined number, but also the user can easily and definitely designate the manipulation information of which deletion is restricted. Thus, user convenience is improved.

Also, the structure for realizing the functions according to the present invention not only can be provided as a pre-prepared manipulation control apparatus, but also can operate a conventional manipulation control apparatus as a manipulation control apparatus of the present invention via a program application. In other words, a manipulation control program for realizing each functional structure of the manipulation control apparatus 110 according to the above embodiment may be applied to a computer (CPU or the like) of the conventional manipulation control apparatus to execute the computer controlling the conventional manipulation control apparatus, so as to operate the conventional manipulation control apparatus as the manipulation control apparatus of the present invention.

A method of distributing such a program is arbitrary, and for example, the program may be distributed through a communication medium, such as the Internet, as well as by being stored in a recording medium, such as a memory card, a CD-ROM, or a DVD-ROM. Also, a manipulation control method of the present invention may be performed by using the manipulation control apparatus 110.

While this invention has been particularly shown and described with reference to exemplary embodiments thereof, it will be understood by one of ordinary skill in the art that various changes in form and details may be made therein without departing from the spirit and scope of the invention as defined by the appended claims.

The present application is based on Japanese Patent Application No. 2010-290727 filed on 27 Dec. 2010. The present application is recorded by referring to all of the specification, the claims, and the drawings of Japanese Patent Application No. 2010-290727.

1. A manipulation control apparatus comprising:
a first obtaining unit which obtains manipulation information for indicating combined manipulations that are combinations of user manipulations;
a first control unit which performs control according to the combined manipulations indicated by the manipulation information obtained by the first obtaining unit;
a storage unit which stores condition information for indicating a condition that is valid when the combined manipulations indicated by the manipulation information obtained by the first obtaining unit are highly likely to be performed again by the user;
a preserve unit which preserves the manipulation information in the storage unit when the combined manipulations indicated by the manipulation information obtained by the first obtaining unit satisfy the condition indicated by the condition information stored in the storage unit;
a second obtaining unit which obtains reattempt designation information designating a combined manipulation corresponding to control of performing again by the user from among the combined manipulations indicated by the manipulation information preserved by the preserve unit; and
a second control unit which performs the control according to the combined manipulation designated using the reattempt designation information obtained by the second obtaining unit,
wherein the storage unit matches and stores information for indicating types of the combined manipulations with a plurality of pieces of condition information respectively indicating a plurality of conditions that are valid when the types of combined manipulations are highly likely to be performed again by the user,
the second obtaining unit additionally obtains designation condition information for indicating the condition information designated by the user from among the plurality of pieces of condition information stored in the storage unit, and
the preserve unit preserves the manipulation information in the storage unit when a condition indicated by the designation condition information obtained by the second obtaining unit is valid among the plurality of pieces of condition information matching the information for indicating the types of combined manipulations indicated by the manipulation information obtained by the first obtaining unit.

2. (canceled)

3. The manipulation control apparatus of claim 1, further comprising a delete unit which deletes at least one piece of the plurality of manipulation information from the storage unit when the number of pieces of manipulation information stored in the storage unit reaches a predetermined number, wherein
the preserve unit preserves the manipulation information obtained by the first obtaining unit in the storage unit storing the number of pieces of manipulation information that is less than the predetermined number;
the second obtaining unit additionally obtains deletion-restricted designation information for designating manipulation information of which deletion is restricted from among the plurality of pieces of manipulation information preserved in the storage unit, and
the delete unit deletes at least one piece of the plurality of manipulation information, which is different from the manipulation information designated as the deletion-restricted designation information obtained by the second obtaining unit.

4. The manipulation control apparatus of claim 1, wherein the combined manipulation highly likely to be performed again comprises a tuning manipulation of changing a frequency set in a tuner used to receive a radio broadcast or television broadcast, and
the condition indicated by the condition information comprises a condition that a following tuning manipulation is not performed over a first period of time or above after the tuning operation has been performed.

5. The manipulation control apparatus of claim 1, wherein the combined manipulation highly likely to be performed again comprises a combined manipulation of reproducing audio or an image, and
the condition indicated by the condition information comprises a condition that the combined manipulation reproducing the audio or image is a combination of a manipulation of searching audio or an image and a manipulation of reproducing found audio or image.

6. The manipulation control apparatus of claim 5, wherein the combined manipulation highly likely to be performed again comprises a manipulation of setting an audio output apparatus for outputting audio, or a manipulation of setting a display apparatus for displaying an image, and
the condition indicated by the condition information comprises a condition that the manipulation of setting the audio output apparatus is a manipulation of setting quality of the audio output by the audio output apparatus, or a condition that the manipulation of setting the display apparatus is a manipulation of setting brightness of the image displayed by the display apparatus.

7. A manipulation control program, which allows a computer to operate as:
a first obtaining unit which obtains manipulation information for indicating combined manipulations that are combinations of user manipulations;
a first control unit which performs control according to the combined manipulations indicated by the manipulation information obtained by the first obtaining unit;
a preserve unit which preserves the manipulation information in the storage unit when the combined manipulations indicated by the manipulation information obtained by the first obtaining unit satisfy a condition that is valid when the combined manipulations are highly likely to be performed again by the user;
a second obtaining unit which obtains reattempt designation information designating a combined manipulation corresponding to control of performing again by the user from among the combined manipulations indicated by the manipulation information preserved by the preserve unit; and
a second control unit which performs the control according to the combined manipulation designated using the reattempt designation information obtained by the second obtaining unit,
wherein the storage unit matches and stores information for indicating types of the combined manipulations with a plurality of pieces of condition information respectively indicating a plurality of conditions that are valid when the types of combined manipulations are highly likely to be performed again by the user,
the second obtaining unit additionally obtains designation condition information for indicating the condition information designated by the user from among the plurality of pieces of condition information stored in the storage unit, and
the preserve unit preserves the manipulation information in the storage unit when a condition indicated by the designation condition information obtained by the second obtaining unit is valid among the plurality of pieces of condition information matching the information for indicating the types of combined manipulations indicated by the manipulation information obtained by the first obtaining unit.

8. A manipulation control method comprising:
a first obtaining operation for obtaining manipulation information for indicating combined manipulations that are combinations of user manipulations;
a first control operation for performing control according to the combined manipulations indicated by the manipulation information obtained by the first obtaining operation;
a preserve operation for preserving the manipulation information in the storage unit when the combined manipulations indicated by the manipulation information obtained by the first obtaining operation satisfy a condition that is valid when the combined manipulations are highly likely to be performed again by the user;
a second obtaining operation for obtaining reattempt designation information designating a combined manipulation corresponding to control of performing again by the user from among the combined manipulations indicated by the manipulation information preserved by the preserve operation; and
a second control operation for performing the control according to the combined manipulation designated using the reattempt designation information obtained by the second obtaining operation,
wherein the storage operation matches and stores information for indicating types of the combined manipulations with a plurality of pieces of condition information respectively indicating a plurality of conditions that are valid when the types of combined manipulations are highly likely to be performed again by the user,
the second obtaining operation additionally obtains designation condition information for indicating the condition information designated by the user from among the plurality of pieces of condition information stored in the storage operation, and
the preserve operation preserves the manipulation information when a condition indicated by the designation condition information obtained by the second obtaining operation is valid among the plurality of pieces of condition information matching the information for indicating the types of combined manipulations indicated by the manipulation information obtained by the first obtaining operation.
